(19) United States
(12) Patent Application Publication
(10) Pub. No.: US 2010/0109549 A1
(43) Pub. Date: May 6, 2010

(54) METHOD AND DEVICE FOR DRIVING A GAS DISCHARGE LAMP

(75) Inventor: Ivo Wilhelmus Johannes Marie Rutten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/525,087

(22) PCT Filed: Feb. 1, 2008
(86) PCT No.: PCT/IB08/50385

§ 371 Date: Jul. 30, 2009

(30) Foreign Application Priority Data
Feb. 6, 2007 (EP) 07101804.8

(51) Int. Cl. H05B 41/30

(52) U.S. Cl. 315/287

(57) ABSTRACT

A method is described for driving a lamp (L), specifically but not necessarily a gas discharge lamp. The lamp is driven with a pulse width modulated lamp current. The lamp current frequency is a constant frequency (fref) modulated with a random or at least pseudo [symbol] random noise signal (Sn). Further, an apparatus (20) for powering a gas discharge lamp (L) is described.

### FIELD OF THE INVENTION

The present invention relates in general to the field of lamps. The present invention relates particularly to gas discharge lamps that are dimmed by pulse width modulation (PWM), such as for instance used in backlighting for LCD television. However, the problem underlying the present invention can also occur in the case of different types of lamps, and the gist of the present invention can also be applied to such lamps of different type, for instance incandescent lamps.

### BACKGROUND OF THE INVENTION

Gas discharge lamps are commonly known, so an elaborate discussion of the design of a gas discharge lamp is not needed here. Suffice it to say that a gas discharge lamp comprises two electrodes located in a closed vessel filled with an ionizable gas or vapor. The vessel is typically quartz or a ceramic, specifically polychrystalline alumina (PCA). The electrodes are arranged at a certain distance from each other, and during operation an electric arc is maintained between those electrodes.

A gas discharge lamp may be powered by an electronic driver. Electronic drivers are commonly known to persons skilled in this art, so an elaborate discussion of the design of electronic drivers is not needed here. Drivers may be designed for applying constant current, commutating current, or duty cycle current to the lamp; in the latter case, a current period is divided into two portions, wherein the current is actually flowing only during the first portion of the current period while no current is actually flowing during the second portion art of the current period. The ratio of duration of the first portion of the current period to the duration of the entire current period is indicated as duty cycle; by varying the duty cycle, the light output of the lamp can be varied (variable dimming). The present invention relates particularly to a driver applying duty cycle current.

Lamps being driven by duty cycle current may be used simply for illumination. However, gas discharge lamps driven by duty cycle current are typically also applied as backlighting for LCD panels, such as for instance used in televisions and monitors.

A problem in such systems is that the periodic switching of the lamp current causes the lamps, their fixtures and components in the power supply (such as transformers, capacitors) to vibrate, the vibration frequency being in the audible range: for persons in the vicinity, this causes an audible hum, which is undesirable. In this respect, it is noted that, in the case of LCD televisions, the current frequency should be synchronized with the TV sync signal (i.e. frame frequency) in order to avoid undesirable image artifacts. Consequently, the current frequency should be an integer multiple of the frame frequency of the TV signal, while further there is an upper limit for practical reasons, typically in the order of a few hundred Hertz. Thus, the number of possibilities for the lamp current frequency is typically low; typically, for example in the case of a PAL system, only the frequencies 100, 150, 200, 250 are potentially applicable. In the case of non-TV applications, there may be less restrictions on the choice of frequencies, but nevertheless audible hum may be generated when a particular frequency is chosen.

### SUMMARY OF THE INVENTION

An object of the present invention is to eliminate or at least reduce the above problem.

According to the present invention, the switching frequency of the lamp current is modulated with a random or pseudo-random signal, i.e. a noise signal. Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating an apparatus for powering a gas discharge lamp according to prior art;

FIG. 2 is a graph schematically illustrating the lamp current as a function of time;

FIG. 3 is a block diagram schematically illustrating an apparatus for powering a gas discharge lamp according to the present invention;

FIG. 4 is a block diagram schematically illustrating an alternative apparatus for powering a gas discharge lamp according to the present invention;

FIG. 5 is a block diagram schematically illustrating another alternative apparatus for powering a gas discharge lamp according to the present invention;

FIG. 6A schematically shows a display device;

FIG. 6B schematically illustrates the application of the present invention in a display device.

### DETAILED DESCRIPTION OF THE INVENTION

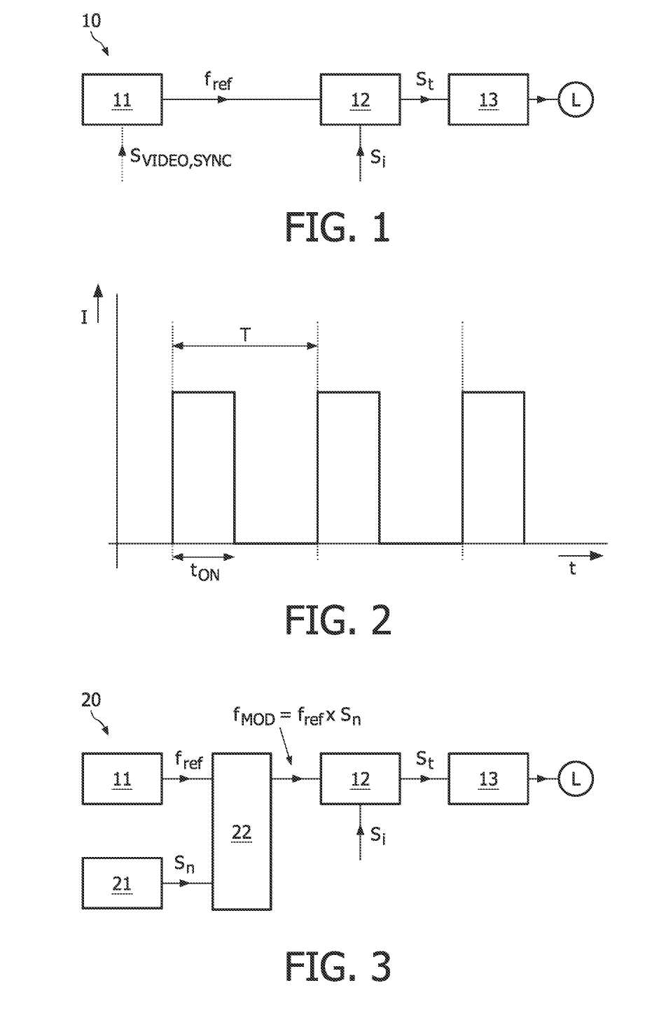

FIG. 1 is a block diagram schematically illustrating a prior art apparatus 10 for powering a gas discharge lamp L. The apparatus 10 comprises a lamp driver 13, providing the actual lamp current I. Since drivers are commonly known, while prior art drivers can be used when implementing the present invention, a detailed description of design and operation of the lamp driver 13 is omitted here. The lamp driver 13 provides a lamp current as illustrated in FIG. 2, which lamp current is shown as having a substantially rectangular wave shape, the current either having a substantial value (the lamp being ON) or being substantially zero (the lamp being OFF). The current period is indicated as T. The duration of the ON-part of the lamp current is indicated as t_{ON}. A duty cycle Δ is defined as Δ=t_{ON}/T. The duty cycle Δ can be varied between a certain minimum value Δmin and 1, thus varying the average lamp current and thus the average light output.

It is noted that said minimum value Δmin generally depends on lamp type, but typically is in the range between 0 and 0.3.

It is further noted that it is not necessary for implementing the present invention that the lamp current has a rectangular wave shape. For instance, it is also possible that the lamp current has a triangular shape, or has a sine shape, or has the shape of a trapezium with rounded corners. Nevertheless, in the following explanation, for sake of simplicity, the rectangular wave shape will be used for illustration.

The lamp driver 13 has the task of generating the lamp current, and of switching the current ON and OFF with the correct timing. A timing signal Sₜ for the ON/OFF switching is provided by a PWM circuit 12. The timing signal Sₜ is generated on the basis of a basic frequency reference signal f_{ref} generated by a frequency reference device 11, and on the basis of an input signal Sᵢ determining the dimming level or duty cycle. For the case of display systems, the figure illustratively shows the video sync signal as reference for the frequency reference device 11. The input signal Sᵢ may be fixed by the manufacturer, or may be a user signal, or may be a signal provided by a light sensor. It is also possible that the signal Sᵢ is derived from the picture content of a video signal. The frequency reference device 11 may be an external device, or may be integrated with the PWM circuit 12. The PWM circuit 12 may be separate from the lamp driver 13, or may be integrated with the lamp driver 13.

An apparatus 20 for powering a gas discharge lamp L in accordance with the present invention is illustrated in FIG. 3. This apparatus 20 is comparable to the apparatus 10 of FIG. 1, with the addition of a frequency modulator 22 arranged between the frequency reference device 11 and the PWM circuit 12. Since frequency modulators are known per se, while further a known frequency modulator can be used when implementing the present invention, a detailed description of design and operation of the frequency modulator 22 will be omitted here.

The apparatus 20 further comprises a noise generator 21, generating a random or pseudo-random signal, or noise signal, Sₙ, which is received at a second input of the frequency modulator 22. Since noise generators are known per se, while further a known noise generator can be used when implementing the present invention, a detailed description of design and operation of the noise generator 21 will be omitted here.

Instead of the fixed frequency reference signal f_{ref}, the PWM circuit 12 now receives the output signal f_{MOD} from the frequency modulator 22, which contains the original fixed frequency reference signal f_{ref} modulated with the noise signal. Thus, with the average current period still being equal to 1/f_{ref}, the frequency spectrum of the lamp current has been broadened, and the energy of possible audible effect is distributed over a wide range. Not only does this mean that the energy content at the original current frequency (i.e. f_{ref}) has been reduced, but a further consequence is that the “sound” is no longer concentrated at one single frequency: in view of the fact that the “sound” is distributed over a range of frequencies, the sound is less deterministic and therefore less discernible.

It is noted that, in stead of using random noise, it is also possible to mix the reference frequency with one single high frequency to move a large part of the spectral energy outside of the audible band. This will, however, still leave some spectral energy inside the audible band, where this energy will be concentrated in one single deterministic frequency (or a plurality of such frequencies), which makes that such energy is more audible (perceived more easily) as compared to the situation proposed by the present invention.

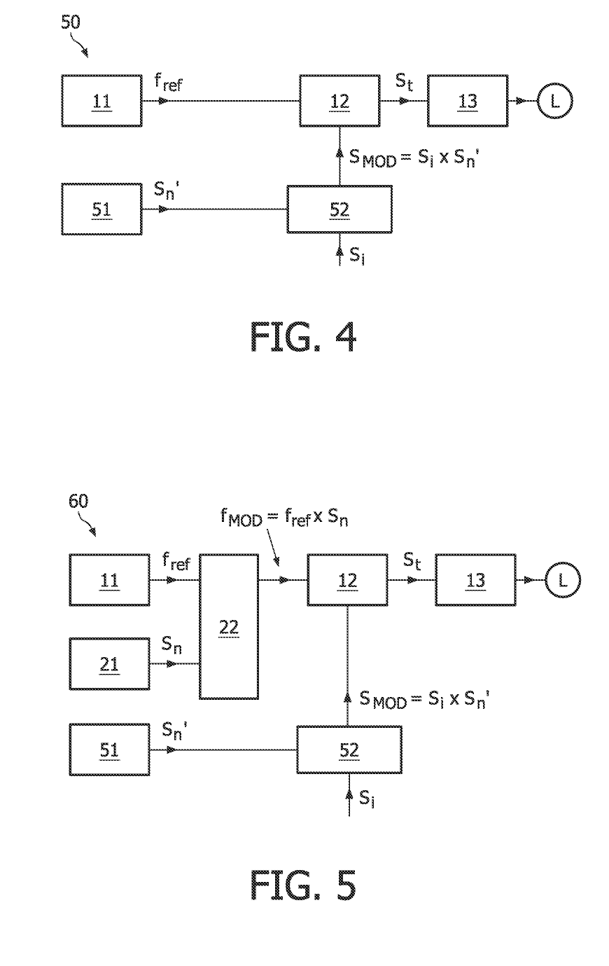

FIG. 4 illustrates an alternative apparatus 50. This alternative apparatus 50 comprises a noise generator 51, generating a random or pseudo-random signal, or noise signal, Sₙ′. The frequency modulator 22 of FIG. 3 is replaced by a frequency modulator 52 having a first input receiving the input signal Si and having a second input receiving the noise signal Sₙ′. Instead of the input signal Si, the PWM circuit 12 now receives the output signal S_{MOD} from the frequency modulator 52, which contains the original input signal Si modulated with the noise signal. This also results in a broadening of the frequency spectrum of the lamp current.

FIG. 5 shows an alternative apparatus 60, illustrating that the noise signals of FIGS. 3 and 4 can be applied together. In such case, it is preferred that the two noise generators 21 and 52 operate independently from each other.

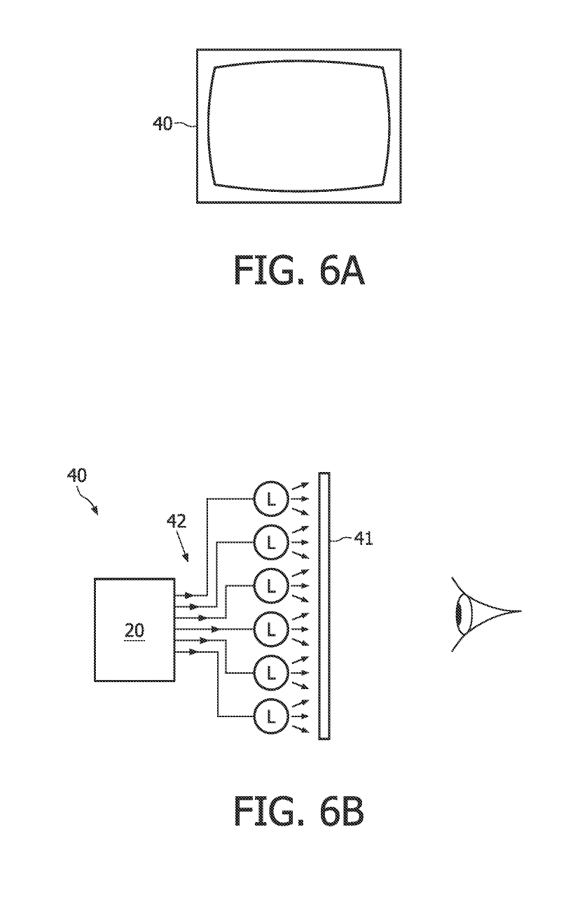

The present invention can be utilized for driving a gas discharge lamp in any application. With reference to FIGS. 6A and 6B, the present invention specifically is useful in the case of LCD-panels with backlighting. FIG. 6A schematically shows a display device 40, for instance a television apparatus or a monitor. FIG. 6B schematically illustrates that the display device 40 comprises an LCD display panel 41 with a backlighting arrangement 42, which comprises an array of gas discharge lamps L and an apparatus 20 for powering the gas discharge lamps in accordance with the principles of the present invention.

Summarizing, the present invention provides a method for driving a lamp L, specifically but not necessarily a gas discharge lamp. The lamp is driven with a pulse width modulated lamp current. The lamp current frequency is a constant frequency f_{ref} modulated with a random or at least pseudo-random noise signal Sₙ. Further, the present invention provides an apparatus 20 for powering a gas discharge lamp L.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, instead of being switched from fully ON to fully OFF, it is possible that the lamp current is switched from a high level to a lower level still higher than zero.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for driving a lamp (L), the method comprising the step of providing a pulse width modulated lamp current, wherein the lamp current frequency is a constant frequency (f_{ref}) modulated with a random or pseudo-random noise signal (Sₙ).

2. Apparatus for powering a lamp (L), comprising:
a frequency reference device providing a fixed basic frequency reference signal (f_{ref});
a PWM circuit generating a timing signal (Sₜ) on the basis of an input frequency reference signal;
a lamp driver providing an lamp current (I) for the lamp, the driver being configured to repetitively switch the lamp current between a high level magnitude and a low level magnitude, the driver being responsive to the timing signal (Sₜ) from the PWM circuit to determine a duty cycle of the lamp current;
a noise generator generating a random or pseudo-random noise signal (Sₙ);
a frequency modulator having a first input receiving the basic frequency reference signal (f_{ref}) and having a second input receiving the noise signal (Sₙ), the modulator being configured to modulate its two input signals with each other and provide a modulated frequency reference output signal (f_{MOD}); wherein the PWM circuit receives the modulated frequency reference output signal (f_{MOD}) from the frequency modulator as input signal to generating the timing signal (Sₜ).

3. Apparatus for powering a lamp (L), comprising:
a frequency reference device providing a fixed basic frequency reference signal (f_{ref});
a PWM circuit generating a timing signal on the basis of an input frequency reference signal and on the basis of a duty cycle input signal (Si);
a lamp driver providing a lamp current (I) for the lamp, the driver being configured to repetitively switch the lamp current between a high level magnitude and a low level magnitude, the driver being responsive to the timing signal (Sₜ) from the PWM circuit to determine a duty cycle of the lamp current;
a noise generator generating a random or pseudo-random noise signal (Sₙ′);
a frequency modulator having a first input receiving the duty cycle input signal (Si) and having a second input receiving the noise signal (Sₙ′), the modulator being configured to modulate its two input signals with each other and provide a modulated duty cycle output signal (S_{MOD}); wherein the PWM circuit receives the modulated duty cycle output signal (S_{MOD}) from the frequency modulator as input signal to generating the timing signal (Sₜ).

4-5. (canceled)
